(19) United States
(12) Patent Application Publication
(10) Pub. No.: US 2014/0318341 A1
(43) Pub. Date: Oct. 30, 2014

(54) SAW WITH ARTICUABLE SIDE VICE AND STOP

(71) Applicant: ANTON FAIT, Boise, ID (US)

(72) Inventor: ANTON FAIT, Boise, ID (US)

(21) Appl. No.: 13/870,485

(22) Filed: Apr. 25, 2013

(51) Int. Cl. B27B 5/29

(52) U.S. Cl. CPC B27B 5/29
USPC 83/477

(57) ABSTRACT

A power saw assembly comprises a saw and base in which the base has a fence and clamp on one or both sides of the cutting plane of the saw, and the assembly has a stop, which allows for repeated cuts of stock to the same length and angle without the necessity of multiple measurements.

### TECHNICAL FIELD

The disclosed embodiments relate generally to power hand tools, and more particularly to power hand tools with platforms for securing a workpiece.

### BACKGROUND

Portable power saws, such as chop and cutoff saws, are cutting machines that typically include a saw attached to a base. The saw is mounted on a hinge or an arm and swings, or otherwise moves, in an up-and-down manner relative to the base. Such saws allow a user to consistently make vertical cuts in a workpiece. Many chop and cutoff saws are provided with at most a fence or clamp on one side of the saw blade plane. So, in a typical application, a user may secure a workpiece at one end, and cut the workpiece to a desired length. The unsecured portion of the workpiece then falls away from the secured portion. A user must also measure the workpiece before making each cut.

In the world of saws, there are several different kinds of saws. A miter saw is a saw that would typically be used for carpentry. It has a fence against which to place a workpiece, and a rotating saw blade that drops through a slot in the deck to cut a workpiece, such as a 2″×4″. The deck and fence extend on both sides of the saw blade. The saw blade may rotate to make angled cuts.

Another type of saw is a cold saw. This is a saw made to cut lighter grades of metal. It is not portable, because it uses a liquid coolant and has a system for recovering the coolant. The cold saw rotates for different angled cuts, and the fences don't swivel on the deck. The cold saw can be undesireable for metal which is to be welded, because the coolant has to be cleaned off before welding.

Another type of saw is a portable metal cutting saw. This type of saw is designed to cut the hardest metal. To do this it has a high horsepower motor, and because it is high horsepower the motor and blade are fixed in position and do not rotate. To make an angled cut there is a fence on the left side of the blade, but not the right side. Because the stock to be cut might be a round bar, there is a vice that presses the workpiece against the fence. Because the workpiece can be round, and the motor is powerful, a person would not hold the round workpiece with his hand or his hand could be pinched if the workpiece rotates. This type of saw has a deck with a saw blade slot to the far edge of the deck, so the cut off part of the workpiece falls away from the blade. If the workpiece were left laying adjacent to the blade if might be caught by the blade and thrown into the user.

A shortcoming of the design of the portable metal cutting saw is that if multiple cuts of the same length of a workpiece need to be cut, the piece has to be measured once for every cut. If the workpiece could be secured on a longer deck against a fence to the right of the blade, with the workpiece secured so it would not be thrown off, a measuring device could speed the making of cuts for the same length of cut.

### SUMMARY OF THE DISCLOSURE

Disclosed is a portable metal cutting power saw assembly with a base that comprises a base, a motor with attached saw blade, and a slot in the base for the saw blade to pass through. On one side of the saw blade is a first fence that may be tilted at an angle, and a vice or clamp for securing a workpiece against the first fence. The saw includes a detachable second deck typically on the right of the saw blade, with a second fence which may be tilted at an angle, and a second vice or clamp for pressing and holding the workpiece against the second fence. The saw also has a stop for providing additional guidance and/or support for making repeated cuts of a workpiece to a measured length. The disclosed technology is particularly adaptable for a user making repeated cuts of multiple pieces of stock to the same length.

In accordance with some embodiments of the disclosed technology, the assembly is provided with a plurality of fences and clamps, at least one on either side of the cutting plane of a saw. Also provided is a stop connected to at least one fence, with the stop allowing a user to measure once, set the stop, and then make repeated cuts of stock to the same length. In this way, the user need not measure repeatedly before cutting each workpiece of a run. The plurality of clamps secures the workpiece or workpieces both before and after a cut is made.

In accordance with some embodiments of the disclosed technology, the assembly is provided with an articuable stop. The stop is movable in three or more dimensions, including up to 6 dimensions, which allows a user considerable latitude in positioning the stop to secure a workpiece or workpieces for a variety of different cuts. Further, the articuable nature of the stop allows a user to make repeated cuts of a common angle without having to make repeated measurements of the angle.

In accordance with some embodiments of the disclosed technology, the a base extension is provided, which allows a user to add a fence, clamp, and stop to a power saw assembly that is not otherwise equipped with fences and clamps on both sides of the cutting plane.

### BRIEF DESCRIPTION OF THE DRAWINGS

FIG. 1 is a perspective view of an embodiment of the disclosed power saw assembly with a plurality of vices and a stop.

FIG. 2 is a perspective view of an embodiment of the disclosed power saw assembly with a plurality of vices and a stop, wherein the stop is shown rotated above and away from the saw base.

FIG. 3 is a perspective view of an embodiment of the disclosed power saw assembly with a plurality of vices and a stop, wherein the stop is shown rotated above and away from the saw base.

FIG. 4 is a perspective view of an embodiment of the disclosed power saw assembly with a plurality of vices and a stop, wherein the base of the assembly comprises two separate and distinct sections.

FIG. 5 is an enlarged perspective view of an embodiment of the disclosed side vice with a stop for a power saw assembly.

### DETAILED DESCRIPTION

Reference will now be made in detail to embodiments, examples of which are illustrated in the accompanying drawings. In the following detailed description, numerous specific details are set forth in order to provide a thorough understanding of the disclosed concepts. It will, however, be apparent to one of ordinary skill in the art that the disclosed concepts may be practiced without these specific details. Well-known methods, procedures, components, circuits, and networks have not been described in detail so as not to unnecessarily obscure aspects of the embodiments.

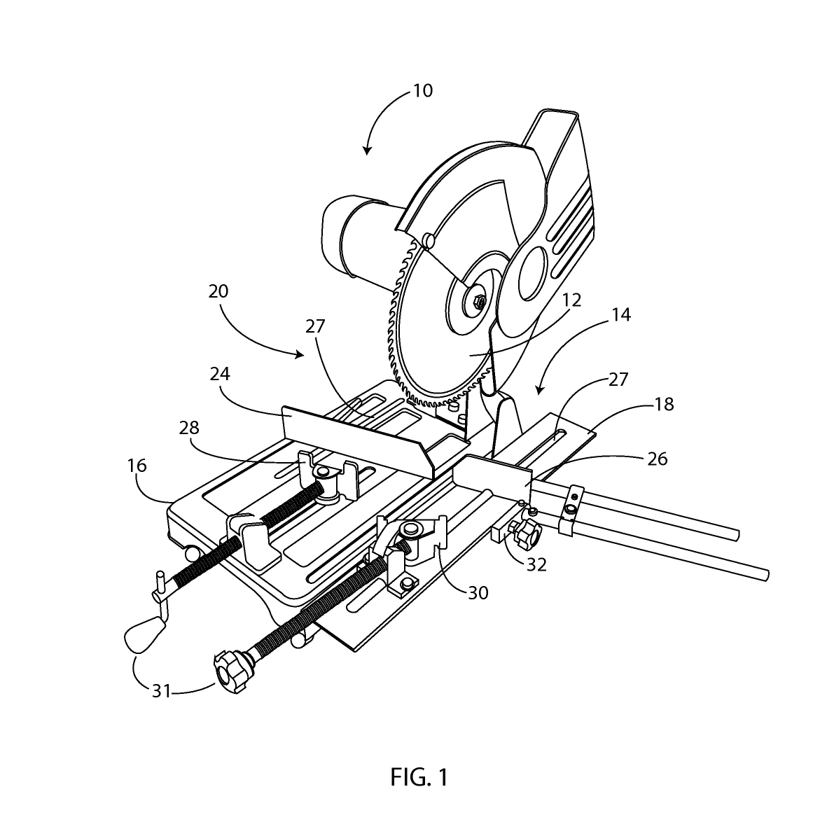

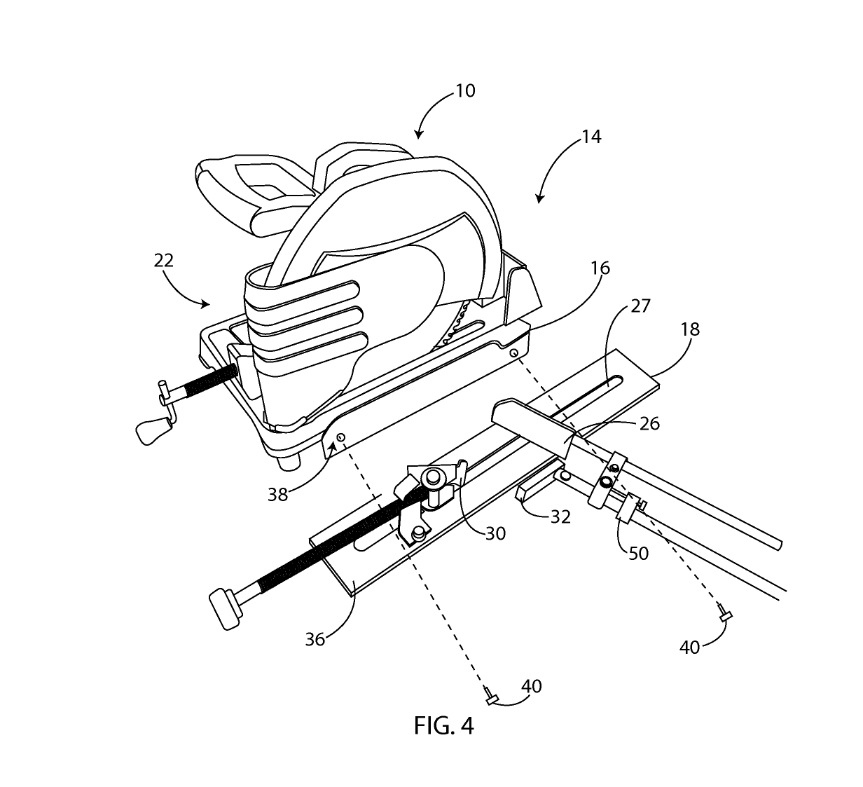

FIG. 1 shows a power saw assembly 10 which comprises a saw 12 moveably attached to a base 14. The base 14 is made up of a first side 16 and a second side 18. The saw 12 is selectively positionable between a raised position 20 and a lowered position 22 (most easily seen in FIG. 4). The saw 12 is moveable between a raised position 20 and a lowered position 22 in a plane normal to the base 14. The blade is in a plane, referred to here as the cutting plane, which divides the first side 16 and the second side 18. There is at least one swivelable fence 24 that is slidably attached to the first side 16. There is also at least one swivelable fence 26 slidably attached the top the second side of the base 18. These fences 24 and 26 may be set in a slot 27 inset into each of the respective sides of the bases 16 and 18, and the fences 24 and 26 may be secured within the slot 27 by a pin, screw, or other post which is capable of tightening and un-tightening, such that the fences 24 and 26 may move toward and away from the attachment point of the saw 12 with the base 14. Those skilled in the art will recognize that a variety of hardware may be used to secure the fences 24 and 26.

A first clamp 28 and a second clamp 30 are shown, which clamps are positioned, respectively, on the first side of the base 16 and second side of the base 18. The clamps are suitable for holding a workpiece to be cut by the saw 12. The second fence 26 and second clamp 30 may be referred to collectively as a side vice. The clamps 28 and 30 could comprise any clamp or vice known in the art to be suitable for holding workpieces in a power tool application. In a preferred embodiment, clamps 28 and 30 are screw-type vices, each with a quick release, which are capable of tightening against a workpiece by operating the handles 31 of the clamps. The assembly 10 is also equipped with an articuable stop 32. The stop 32 is physically connected to the fence 26 and is adjustable in three dimensions to create a surface against which workpieces may be placed so a user of the assembly 10 may make repeated cuts of stock, the length of which cuts are designated by the stop.

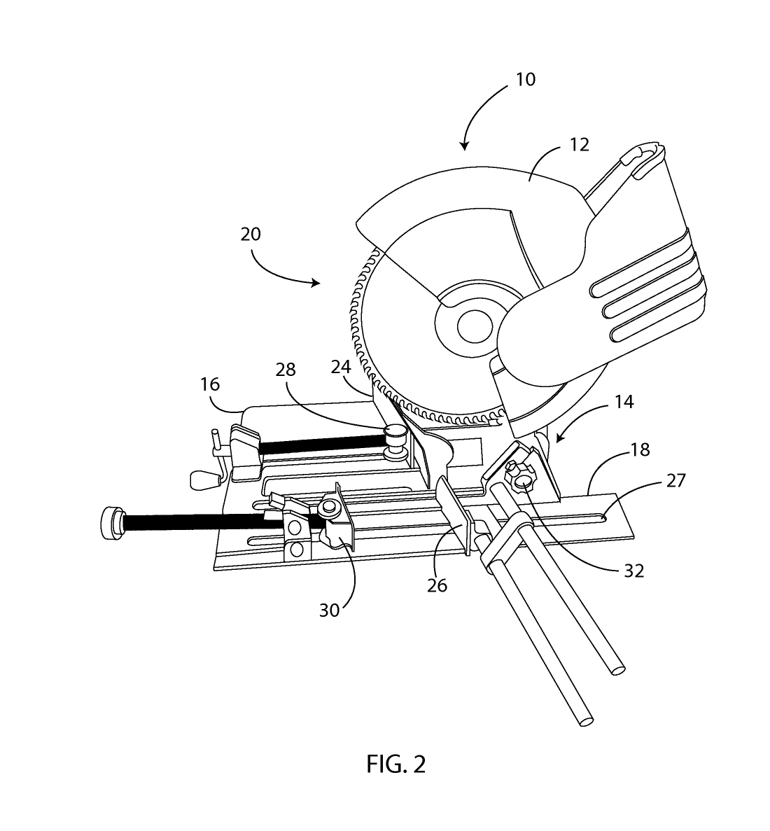

FIG. 2 shows the assembly 10, with the base 14, from a side angle, wherein the articuable nature of the stop 32 is visible. The stop 32 may pivot about an axis which is parallel to fence 26 so the stop may be positioned to receive, and such that a user may place against it, a workpiece. The articuable nature of the stop 32 is further explained below.

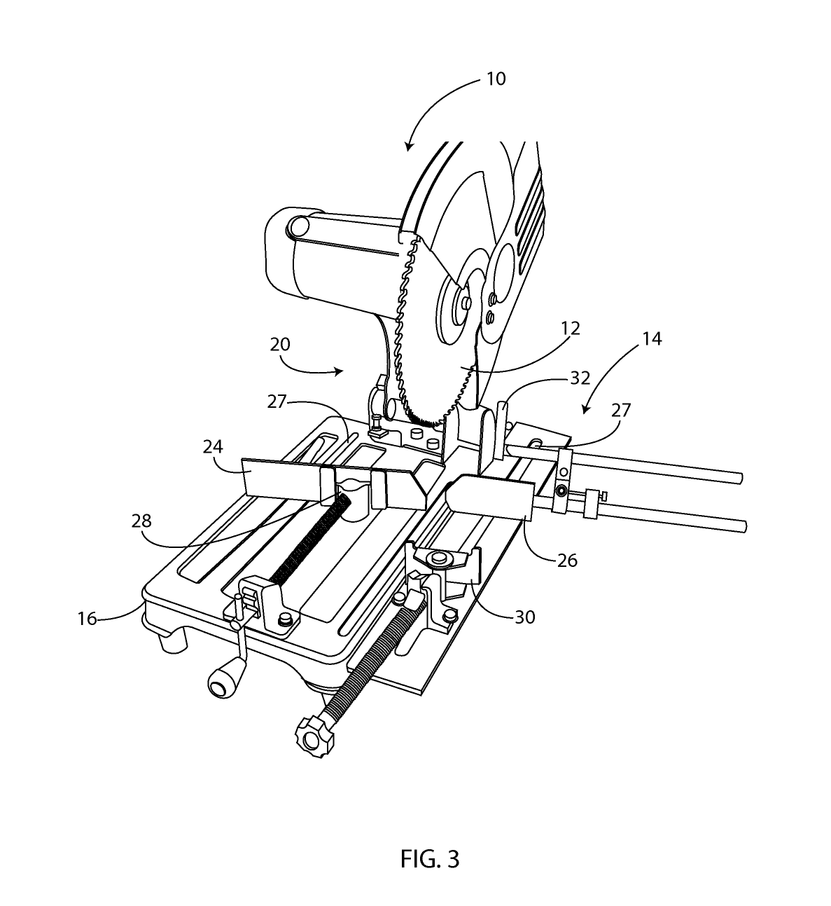

FIG. 3 shows another view of the assembly 10, wherein the clamp 28 is positioned against the fence 24, while the second clamp 30 is positioned away from the fence 26. In this view, the independent nature in which the clamps 28 and 30 operate may be seen. Further, the stop 32 is shown swung up and away from the fence 26. In FIGS. 1 and 2 and 5, the stop 32 is shown in one configuration. The stop 32 in FIGS. 3 and 4 is a version of the stop which includes a fine adjustment screw. In FIG. 3, the saw 12 is in a raised position 20. In a preferred embodiment, the saw 12 is attached to the base 14 via a hinge, which allows the saw 10 to move in a plane normal to the base 14. The space between the fence 24 and the fence 26 allows the saw to pass through the base 14 to make cuts in a workpiece.

In FIG. 4, the assembly 10 is depicted in an embodiment wherein the base 14 comprises two separate and distinct sections 16 and 18. In such an embodiment, the second side of the base 18 is physically removable from the first side 16. In such an embodiment, the second side 18 is referred to as a base extension. The base extension comprises an extension platform 36 platform 36 that may be attached and removed the attachment side 38 of the first section 16 of the base 14. The extension platform 36 may be attached by nuts, washers, and bolts or other comparable fasteners known in the art. When the second side 18 is attached to the first side 16 the assembly 10 is operable as described supra. Another configuration of the device is one in which the saw base is made up of sides 16 and 18, and they are not separable.

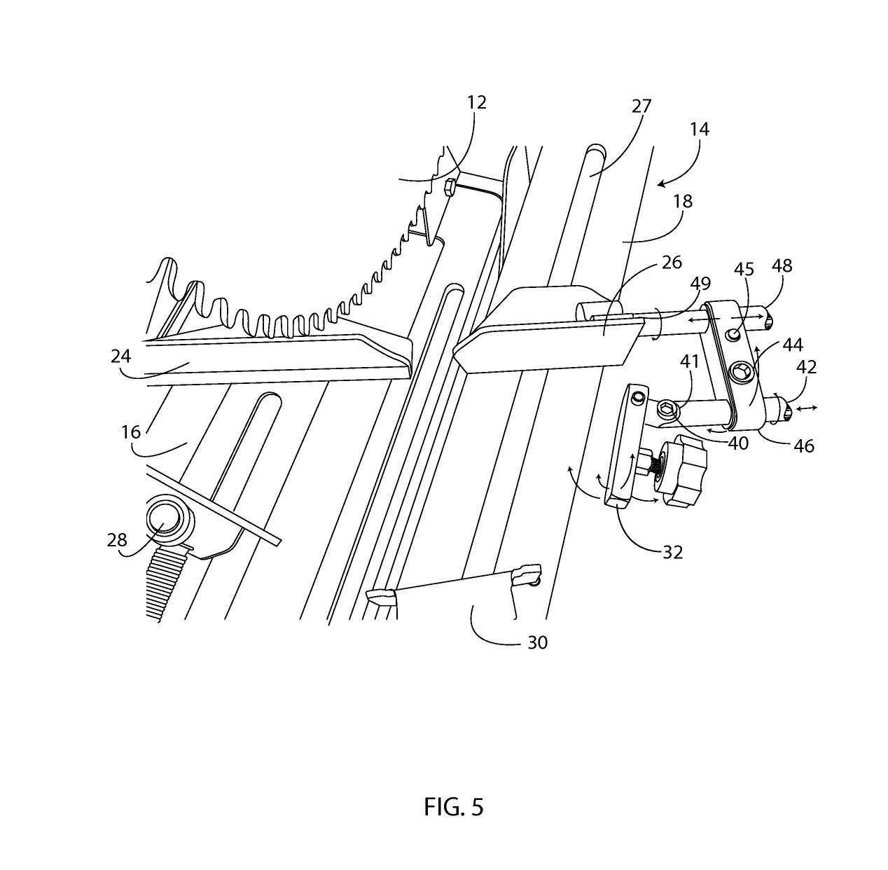

FIG. 5 provides additional detail for the articuable nature of the stop 32, including the multiple directions the stop is capable of moving. In the embodiment depicted, a user may adjust the angle of the stop 32 by pivoting the stop 32 about the axis defined by the bolt 40, which is disposed in the stop end 41 of the rod 42. The user may also adjust the angle of the stop 32 by loosening the bolt 44, which in turn loosens the bracket 46 such that the stop 32 may pivot about the axis defined by the rod 42. Alternatively, a user may loosen the bolt 45, which in turn loosens the bracket 46 such that the stop 32 may pivot about the axis defined by the rod 48. A user may also loosen a bolt, which is not shown, at the fence end 49 or the rod 48 to allow the stop 32 to pivot about the axis defined by the rod 48. The rods 46 and 48 are disposed in a parallel manner, while the bracket 44 is at an angle normal to both rods 46 and 48.

The stop 32 shown in FIG. 4 works in a similar manner to that shown in FIG. 5. In addition to the bolts shown in FIG. 5, the stop 32 of FIG. 4 includes a fine adjustment control 50, which can be used to move the stop 32 in small increments and can be locked in place at the preferred position.

The clamps 28 and 30 are pivotable independent of one another, thus providing a user flexibility in securing a workpiece or workpieces. Those skilled in the art will recognize that the saw 12 is capable of fitting between the fence 24 and 26, thus allowing one to completely cut a workpiece.

The foregoing description, for purpose of explanation, has been described with reference to specific embodiments. The illustrative discussion above, however, is not intended to be exhaustive or to limit the disclosed concepts to any particular form. The embodiments were chosen and described in order to best explain the principles of the disclosed concepts in order to enable others skilled in the art.

What is claimed is:

1. A power saw assembly comprising:
a saw blade and saw motor attached to a cutting deck, with the saw blade and motor configured for movement in a single plane normal to the plane of the desk between a raised position and a lowered position;
a blade slot in said cutting deck for passage of said saw blade when moved to a lowered position, with the blade slot dividing the cutting deck into a first and a second side of said deck;
a first swivelable fence slideably attached atop said deck on said first side, and configured to swivel in the same plane as the cutting deck plane and to be secured in a selected position;
a second swivelable fence slideably attached atop said deck on said second side;
a first clamp configured to secure a workpiece to said first swivelable fence on said first side;
a second clamp configured to secure a workpiece to said second swivelable fence on said second side; and
an articuable stop attached to said second fence on said second side;
whereby said stop is adjustably fixable to create a surface against which workpieces may be placed to allow repeated cuts of stock to a length defined by the stop.

2. The power saw assembly of claim 1 wherein said clamp is a screw-type vice with a quick release.

3. The power saw assembly of claim 1 comprising at least one clamp capable of clamping a workpiece to said first swivelable fence.

4. The power saw assembly of claim 3 wherein said at least on clamp on said first side and said at least one clamp on said second side are screw-type vices each having a quick release.

5. The power saw assembly of claim 3 wherein said first and second sides are physically discrete sections removably affixable to one another.

6. The power saw assembly of claim 1 wherein said articuable stop comprises:
a first rod, with a stop end, connected to a stop at said stop end, wherein said stop is adjustably secured to said stop end by way of a bolt;
a second rod, with a fence end, connected to a fence at said fence end, wherein said rod is adjustably secured to said fence by way of a bolt;
said first and second rods disposed parallel to one another; and
a bracket having a first end and a second end, disposed at an angle normal to said rods, and connected to said first rod at said first end and connected to said second rod at said second end, wherein each of said ends of said bracket are adjustably secured to said rods by way of bolts.

7. A base extension with a fence and clamp for a power saw wherein the saw is movably attached to a base having a first side and an attachment side, the saw being selectively positionable between a raised position and a lowered position, with the blade of the saw in a plane normal to the base, the plane of the saw defining the first and attachment sides, said extension comprising:
a removably affixable extension platform for affixing to said attachment side of said base;
at least one swivelable fence slideably attached atop said extension platform;
at least one clamp capable of clamping a workpiece to said swivelable fence; and
an articuable stop attached to said at least one fence;
whereby said stop is adjustably fixable to create a surface against which workpieces may be placed to allow repeated cuts of stock to a length defined by the stop.

8. The base extension of claim 7 wherein said clamp is a screw-type vice with a quick release.

9. The base extension of claim 7 wherein said articuable stop comprises:
a first rod, with a stop end, connected to a stop at said stop end, wherein said stop is adjustably secured to said stop end by way of a bolt;
a second rod, with a fence end, connected to a fence at said fence end, wherein said rod is adjustably secured to said fence by way of a bolt;
said first and second rods disposed parallel to one another; and
a bracket having a first end and a second end, disposed at an angle normal to said rods, and connected to said first rod at said first end and connected to said second rod at said second end, wherein each of said ends of said bracket are adjustably secured to said rods by way of bolts.
